(19) United States
(12) Patent Application Publication
(10) Pub. No.: US 2004/0049399 A1
(43) Pub. Date: Mar. 11, 2004

(54) Method and system for online donation and sending customized card

(76) Inventors: Elisabeth Familian, Beverly Hills, CA (US); Shelby White, New York, NY (US)

Correspondence Address: Michael A. Rahman, Esq., Kintera, Inc., Suite 240, 9605 Scranton Road,, San Diego, CA, 92121, US

(21) Appl. No.: 10/241,684

(22) Filed: Sep. 10, 2002

(51) Int. Cl. G06F 17/60

(52) U.S. Cl. 705/1

(57) ABSTRACT

It is an object of the present invention to provide an improved system and method for making an online donation to a nonprofit, charitable, religious or other organization in the name of a third party honoree and sending a customized card. In accordance with one embodiment of the invention, a method for making an online donation in the name of a third party honoree and sending a customized card, comprises the steps of selecting, on a website, a link to an online donation processing service, making a donation in the name of a third party honoree, creating the customized card, printing the card, and sending the card to the third party honoree or to a designated recipient. The method further comprises the step of creating a tribute page for the honoree. The method further comprises the step of emailing the tribute page to friends, family or others and soliciting donations from them. The method further comprises the step of recognizing donors in a virtual plaque.

In one embodiment, a system for making an online donation to a nonprofit organization in the name of a third party honoree and sending a customized card, comprises a link, on a website, to an online donation processing service, means for making an online donation in the name of a third party honoree, means for processing the online donation, means for creating the customized card, and means for sending the card to the third party honoree or a designated recipient.

### BACKGROUND

1. Field of Invention

The present invention relates generally to online donations. More specifically, the present invention relates to a method and system for making an online donation to a nonprofit, charitable, religious, political or other organization in the name of a third party honoree and automatically printing and sending a customized acknowledgment card to the honoree or the friends and family of the honoree.

2. Description of Prior Art

Charitable, nonprofit, religious, political and other organizations use the Internet to raise money online. Recently, two United States patent applications entitled “SYSTEM AND METHOD FOR INTERACTIVE FUNDRAISING OVER A WIDE-AREA NETWORK”, Ser. No. 740761, and “METHOD AND SYSTEM FOR AN EFFICIENT FUNDRAISING CAMPAIGN OVER A WIDE AREA NETWORK”, Ser. No. 764787, both assigned to Kintera, Inc. have been published. These patent applications are directed to online interactive fundraising schemes on the Internet that allow nonprofit and charitable organizations to raise funds as well as to promote their cause.

What is needed is an efficient need for method and system that allows a donor to make an online donation in the name of a third party honoree and to automatically print and send a customized acknowledgment card to the honoree or the friends and family of the honoree.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a flow diagram of the method steps for implementing an online donation service in accordance with one embodiment of the invention; and

FIG. 2 is a system-level block diagram of one embodiment of the invention.

### DETAILED DESCRIPTION OF THE INVENTION

The present invention is directed to an online donation method and system for nonprofit, charitable and other organizations. In one embodiment, the invention allows donors to go to a website and make a donation in the name of a third party honoree. The website and the service can be provided by a nonprofit, charitable, for-profit or any other organization. The website and the service can also be provided by an individual.

Donors provide information about the third party honoree that is retained in a computer network, a database or other storage means connected to the Internet. A printer (e.g., a laser printer) linked to the network is used to create and print a customized acknowledgment card that is sent to the honoree. The donor is sent a receipt for tax purposes.

The invention allows the convenience of making a donation online in the name of a third party honoree and then automatically prepare and print a customized acknowledgment card. Each card is customized according to the needs of the donor and is sent to the honoree.

In one embodiment, one or more links to an online donation processing service is placed on a website. The website can be a nonprofit, charitable, for-profit or any other organization's or an individual's website. The donation processing service allows a donor to make a tribute donation (e.g., “give a gift in honor of someone”), a memorial donation (e.g., “give a gift in memory of someone”), or a donation for a special occasion (e.g., “give a gift for an occasion”) in honor of a third party honoree. Visitors to the website can click on one of these links and be transferred to an online donation processing service. The donor provides information necessary to enable the service to process the donation by credit card, check or other means and to deliver a receipt for tax purposes.

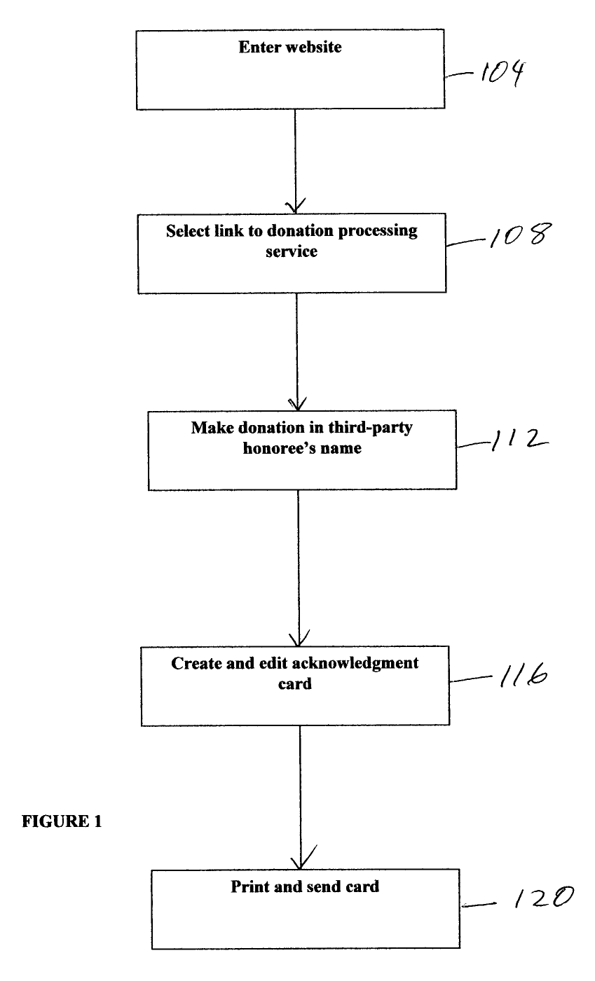

FIG. 1 is a flow diagram of the method steps for implementing an online donation service in accordance with one embodiment of the invention. The method begins at step 104 where a potential donor enters a website using a computer. The website includes a link to a donation processing service. The website can be maintained by a nonprofit, charitable, religious, political or for-profit organization or an individual.

In step 108, the donor selects the link to the donation processing service. By selecting the link, the donor is transferred to the donation processing service. The donation processing service is connected to a computer network that is connected to the Internet. The online donation processing service can be operated by a service provider such as Kintera, Inc. or any other service provider on behalf of an organization or by the organization itself. The donation processing service allows the donor to make a donation online to a nonprofit or a charitable organization in the name of a third party honoree.

Next, in step 112, the donor makes a donation in the name of a third party honoree. The donor can make the donation using a credit card, by mail or any other suitable means. The donor enters honoree's information (such as, for example, name, address, etc.) that is retained in a computer network, a database or other storage means. Next in step 116, the donor uses the computer to automatically create a customized acknowledgment card for the honoree. The customized card can include the nonprofit or charitable organization's logo. The donor can create, preview, edit and modify the customized card using a personal computer linked to the Internet. The donor can include a personalized message for the honoree in the card.

Next, in step 120, a laser printer or other printing device connected to the network is used to print the acknowledgment card for the honoree. In one embodiment of the invention, a receipt for tax purposes is emailed to the donor. The donor can print the tax receipt for his or her use. The acknowledgment card is then sent to the honoree by mail, email or other means.

In one embodiment of the invention, a tribute page is created on the Internet for the honoree. The tribute page is a web page that includes information about the honoree. For example, the tribute page can include the honoree's photo, a biography or other information about the honoree. The tribute page can also include information about the nonprofit, charitable or other organization that is the beneficiary of the donations.

In one embodiment of the invention, the tribute page can be emailed to the friends and family of the honoree. For example, the donor can email the tribute page to the friends and family of the honoree and solicit donation in honor of the honoree. Recipients of the email with the tribute page can then make a donation or email it to others. Thus, the invention allows a donor to send the tribute page to others and solicit donations in honor of the honoree. The invention also allows the nonprofit, charitable or other beneficiary organizations to receive more donations by reaching out to more potential donors.

In one embodiment of the invention, donors are acknowledged in a virtual plaque. The virtual plaque can include a list of all donors that have contributed in honor of the honoree. The virtual plaque can be included in the tribute page or can be placed in another web page. The email capabilities described above allow the initial donor to reach out to additional donors and thus increase the probability of additional donations. The virtual plaque recognizes each donor that has donated in honor of the honoree. The opportunity for recognition provides a motivation for additional donors to make a donation. The virtual plaque is described in detail in two United States patent applications entitled “SYSTEM AND METHOD FOR INTERACTIVE FUNDRAISING OVER A WIDE-AREA NETWORK”, Ser. No. 740761, and “METHOD AND SYSTEM FOR AN EFFICIENT FUNDRAISING CAMPAIGN OVER A WIDE AREA NETWORK”, Ser. No. 764787, both assigned to Kintera, Inc., and they are incorporated herein by reference in their entirety for all purposes.

In one embodiment, an email reminder is sent periodically to the donor (e.g., once a month, once every six month or once every year). The email asks if the donor would like to make another donation and send a customized card to a designated recipient.

In one embodiment, a customized card is automatically sent to the honoree or the friends and family of the honoree on special occasions, such as for example, birthdays, anniversaries or other special occasions. For example, information such as the honoree's date of birth or other information is retained in the computer network or the database. The donor can opt to have a customized card sent to the honoree or the friend or family of the honoree once every year on a special day, such as a birthday. The invention automatically creates, prints and sends a customized card to the designated recipient.

In one embodiment, the acknowledgment card is created by the service provider. The donor provides information about the honoree to enable the service provider to create a customized acknowledgment card. The card is then printed and sent to the honoree.

The invention provides an efficient means for increasing online donations, including tribute and memorial donations. The service allows donors to conveniently make a donation online in the name of a third party honoree, automatically create and print a customized acknowledgment card, and send the acknowledgment card to the honoree or the friends and family of the honoree. For example, a donor can make a donation to the honoree's favorite charity, create a customized card with the charity's name and logo, and send the card to the honoree or the friends and family of the honoree. The service allows the donor to customize the message in the acknowledgment card.

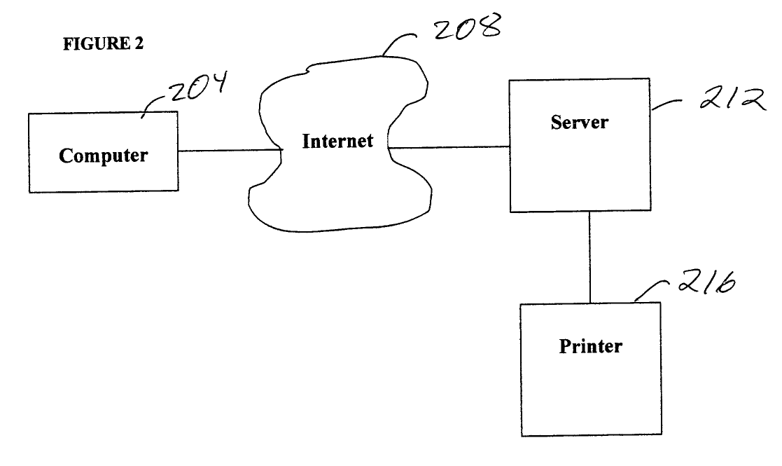

FIG. 2 is a system-level block diagram of one embodiment of the invention. A computer 204 is linked to a server 212 (or a database or a storage device) via a wide area network, such as the Internet 208. The server 212 provides a donation processing service that allows donors to make an online donation to a nonprofit, charitable, religious or other organization. A donor uses the computer 204 to connect to the server 212 via the Internet 208. The donor makes a donation online, and then creates a customized card for a third party honoree. The donor can preview, edit and modify the card online. Once the donor is satisfied with the card, a laser printer 216 (or any other printing device) prints the card and the card is then sent to the honoree or the friends and family of the honoree. In one embodiment, the server 212 and the printer 216 are provided and maintained by a service provider.

Thus, there has been provided, in accordance with the present invention, an online donation method and system. Although the preferred embodiment has been described, it should be understood that various changes, substitutions, and alterations can be made herein without departing from the scope of the present invention. Other examples of changes, substitutions, and alterations are readily ascertainable by one skilled in the art and could be made without departing from the spirit and scope of the present invention as defined by the following claims.

What is claimed is:

1. A method for making an online donation in the name of a third party honoree and sending a customized card to the honoree or the friend or family of the honoree (hereinafter referred to as the “designated recipient”), comprising the steps of:
selecting, on a website, a link to an online donation processing service;
making a donation in the name of a third party honoree;
creating the customized card for the third party honoree;
printing the card; and
sending the card to the designated recipient.

2. The method according to claim 1, further comprising the step of previewing the card.

3. The method according to claim 1, further comprising the step of editing and modifying the card.

4. The method according to claim 1, further comprising the step of creating a tribute page, wherein the tribute page is a web page containing information about the third party honoree.

5. The method according to claim 4, further comprising the step of including a photo of the third party honoree in the tribute page.

6. The method according to claim 4 further comprising the steps of:
emailing the tribute page to friends, family or others;
soliciting donations from the friends and family in honor of the third party honoree.

7. The method according to claim 6, further comprising the step of recognizing the donors in a virtual plaque.

8. The method according to claim 1, wherein the donation is made to a charitable organization.

9. The method according to claim 1, wherein the donation is made to a nonprofit organization.

10. The method according to claim 1, wherein the donation is a tribute donation in the name of the honoree.

11. The method according to claim 1, wherein the donation is a memorial donation in the name of the honoree.

12. The method according to claim 1, further comprising the step of including a customized message for or about the honoree in the card.

13. The method according to claim 1, further comprising the step of including the nonprofit organization's logo in the card.

14. The method according to claim 1, further comprising the step of including information about the nonprofit organization in the card.

15. The method according to claim 1, further comprising the step of making the donation by a credit card.

16. The method according to claim 1, further comprising the step of making the donation by a check.

17. A method for processing an online donation in the name of a third party honoree and sending a customized card to the third party honoree or another designated recipient, comprising the steps of:
providing, on a website, a link to an online donation processing service;
receiving a donation in the name of the third party honoree;
creating the customized card;
printing the card; and
sending the card to the third party honoree or another designated recipient.

18. The method according to claim 17 further comprising the step of creating a tribute page.

19. The method according to claim 18, further comprising the steps of:
emailing the tribute page to others; and
soliciting donations in honor of the third party honoree.

20. The method according to claim 19 further comprising the step of recognizing the donors in a virtual plaque.

21. The method according to claim 18 further comprising the step of editing and modifying the card.

22. The method according to claim 18 further comprising the step of previewing the card.

23. A system for making an online donation to a nonprofit organization in the name of a third party honoree and sending a customized card, comprising:
a link, on a website, to an online donation processing service;
means for making an online donation in the name of a third party honoree;
means for processing the online donation;
means for creating the card; and
means for sending the card to the third party honoree.

24. The system according to claim 14 further comprising means for editing and modifying the card.

25. A computer program product including a program code embodied in a storage medium for carrying out the method steps for making an online donation in the name of a third party honoree and sending a customized card, comprising the steps of:
selecting, on a website, a link to an online donation processing service;
making a donation in the name of a third party honoree;
creating the customized card; and
printing the card.
